(19) United States
(12) Patent Application Publication
(10) Pub. No.: US 2024/0019747 A1
(43) Pub. Date: Jan. 18, 2024

(54) ELECTROCHROMIC DISPLAY DEVICE AND MANUFACTURING METHOD THEREOF

(71) Applicants: HUIZHOU CHINA STAR OPTOELECTRONICS DISPLAY CO., LTD., Huizhou (CN); TCL CHINA STAR OPTOELECTRONICS TECHNOLOGY CO., LTD., Shenzhen (CN)

(72) Inventors: Siyang Tu, Huizhou (CN); Hangchuan Zhang, Huizhou (CN); Lixuan Chen, Huizhou (CN)

(73) Assignees: HUIZHOU CHINA STAR OPTOELECTRONICS DISPLAY CO., LTD., Huizhou (CN); TCL CHINA STAR OPTOELECTRONICS TECHNOLOGY CO., LTD., Shenzhen, Guangdong (CN)

(21) Appl. No.: 17/822,791

(22) Filed: Aug. 28, 2022

(30) Foreign Application Priority Data
Jul. 15, 2022 (CN) 202210836295.0

(51) Int. Cl. G02F 1/1516; G02F 1/155; C09K 9/02

(52) U.S. Cl. CPC G02F 1/15165; G02F 1/155; C09K 9/02; G02F 2001/164

(57) ABSTRACT

The present application discloses an electrochromic display device and a manufacturing method thereof. The electrochromic display device includes a first transparent substrate and an electrochromic pixel arrays disposed on the first transparent substrate. The electrochromic pixel arrays includes a plurality of structural units superimposed longitudinally, and a second transparent substrate disposed on each of the structural units; the structural units include common electrodes, pixel electrodes, electrochromic layers, and electrolytes; the electrochromic layers are in a transparent state or a colored state based on an applied voltage; the structural units are independently selected from one of a cyan structural unit, a magenta structural unit, and a yellow structural unit; and the electrochromic pixel arrays includes the cyan structural unit, the magenta structural unit, and the yellow structural unit.

### BACKGROUND OF INVENTION

### Field of Invention

The present application relates to a field of display, and specifically to an electrochromic display device and a manufacturing method thereof.

### Description of Prior Art

There are some problems in existing electrochromic display devices, most of the devices can only realize black-and-white display; some colored display devices are composed of three RGB sub-pixels arranged in parallel, when the colored display devices are used as reflective display devices, this design will significantly reduce reflectivity and color gamut of the devices.

### SUMMARY OF INVENTION

A purpose of the present application is to provide an electrochromic display device, which can solve at least one shortcoming of the prior art.

The present application provides the electrochromic display device, which includes a first transparent substrate and electrochromic pixel arrays disposed on the first transparent substrate, wherein the electrochromic pixel arrays include a plurality of structural units superimposed longitudinally, and a second transparent substrate disposed on each of the structural units.

The structural units include a common electrode, a pixel electrode, and an electrochromic layer disposed between the common electrode and the pixel electrode, and the electrochromic layer is disposed on a surface of the pixel electrode; each of the structural units further includes an electrolyte, the electrolyte is in contact with the electrochromic layer; the electrochromic layer is displayed in a transparent state or a colored state based on an applied voltage.

The structural units are independently selected from one of a cyan structural unit, a magenta structural unit, and a yellow structural unit; and the electrochromic pixel arrays includes the cyan structural unit, the magenta structural unit, and the yellow structural unit.

Alternatively, in some embodiments of the present application, a material of the electrochromic layer includes an organic polymer electrochromic material; the organic polymer electrochromic material includes at least one of polypyrrole, polythiophene, and polyaniline.

Alternatively, in some embodiments of the present application, a thickness of the electrochromic layer ranges from 100 nm to 5 μm.

Alternatively, in some embodiments of the present application, the electrochromic layer of the cyan structural unit includes a cyan polymer electrochromic material, and an absorption peak of a colored state of the cyan polymer electrochromic material is in a red-light wave band, in which the electrochromic layer of the cyan structural unit displays cyan.

Alternatively, in some embodiments of the present application, the electrochromic layer of the magenta structural unit includes a magenta polymer electrochromic material, and an absorption peak of a colored state of the magenta polymer electrochromic material is in a green-light wave band, in which the electrochromic layer of the magenta structural unit displays magenta.

Alternatively, in some embodiments of the present application, a yellow polymer electrochromic material, and an absorption peak of a colored state of the yellow polymer electrochromic material is in a blue-light wave band, in which the electrochromic layer of the yellow structural unit displays yellow.

Alternatively, in some embodiments of the present application, wherein the electrochromic layer is disposed in the electrolyte; the electrolyte includes lithium ions (Li+) and/or ionic liquids.

Alternatively, in some embodiments of the present application, the ionic liquids are selected from one or more of trifluoromethane sulfonimide ([Tf₂N]), 1-butyl-3-methylimidazolium tetrafluoroborate ([Bmim][BF₄]), 1-butyl-3-methylimidazolium hexafluorophosphate ([Bmim][PF₆]).

Alternatively, in some embodiments of the present application, the electrochromic layer is in the transparent state when a positive voltage is applied; and the electrochromic layer is in the colored state when a negative voltage is applied.

Alternatively, in some embodiments of the present application, voltages of electrochromic layers of each of the structural units are same or are different.

Alternatively, in some embodiments of the present application, the common electrode and the pixel electrode are transparent electrodes; the pixel electrode is connected to a thin film transistor (TFT).

Alternatively, in some embodiments of the present application, the cyan structural unit includes a first common electrode, a first electrolyte, a cyan electrochromic layer, and a first pixel electrode disposed in sequence.

Alternatively, in some embodiments of the present application, the magenta structural unit includes a second common electrode, a second electrolyte, a magenta electrochromic layer, and a second pixel electrode disposed in sequence.

Alternatively, in some embodiments of the present application, the yellow structural unit includes a third common electrode, a third electrolyte, a yellow electrochromic layer, and a third pixel electrode disposed in sequence.

Alternatively, in some embodiments of the present application, a structural formula of the cyan polymer electrochromic material is as follows:

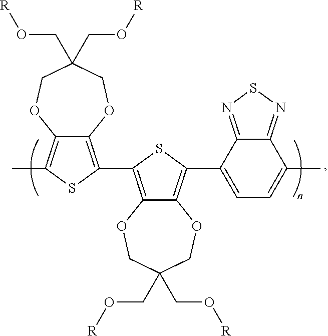

wherein R is 2-ethylhexyl.

Alternatively, in some embodiments of the present application, a structural formula of the magenta polymer electrochromic material is as follows:

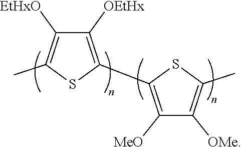

Alternatively, in some embodiments of the present application, a structural formula of the yellow polymer electrochromic material is as follows:

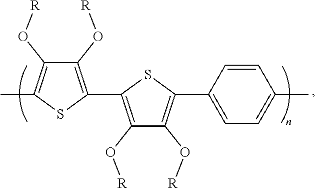

wherein R is 2-ethylhexyl.

Accordingly, the present application further provides a manufacturing method of an electrochromic display device, which includes following steps:
providing a first transparent substrate; and
forming a plurality of structural units superimposed longitudinally, and a second transparent substrate on the first transparent substrate, that is, forming an electrochromic pixel arrays on the first transparent substrate; the electrochromic pixel arrays including a cyan structural unit, a magenta structural unit, and a yellow structural unit;
wherein a manufacturing method of each of the structural units includes: forming a pixel electrode, an electrochromic layer, and a common electrode in sequence, the electrochromic layer is formed on a surface of the pixel electrode; and filling an electrolyte, so as to obtain the structural units; the structural units are independently selected from one of the cyan structural unit, the magenta structural unit, and the yellow structural unit.

Alternatively, in some embodiments of the present application, the electrochromic layer is prepared by an electrochemical polymerization process, which includes a following step:
immersing the pixel electrode in the electrolyte including at least one electrochromic polymer monomer and forming a film by polymerizing the electrochromic polymer monomer on a surface of the pixel electrode under an action of an external voltage, thereby obtaining the electrochromic layer.

In the present application, national television standards committee (NTSC) color gamut refers to a sum of colors under a NTSC standard.

Beneficial effects of the present application comprises:
the electrochromic display device of the present application is a non-active light-emitting display device, which can realize transparent display and color display, and its color gamut can reach 8.5% NTSC color gamut. Compared with a design in which RGB sub-pixels are arranged side-by-side, cyan-magenta-yellow (CMY) pixel units adopt a laminated design, which greatly improves color gamut, reflectivity, and resolution.

### BRIEF DESCRIPTION OF DRAWINGS

In order to more clearly explain technical solutions in embodiments of the present application, following will briefly introduce drawings that need to be used in description of the embodiments. It is obvious that the drawings in the following description are only some embodiments of the present application. For those skilled in the art, other drawings can be obtained according to these drawings without paying creative labor.

FIG. 1 is a schematic structural diagram of a structural unit and transparent substrates disposed on an upper side and a lower side of the structural unit provided by an embodiment of the present application.

FIG. 2 is a schematic structural diagram of an electrochromic display device provided by the embodiment of the present application.

FIG. 3 is absorption spectrums of polymer electrochromic materials provided by the embodiment of the present application.

FIG. 4 is a schematic diagram of a color-changing display of the electrochromic display device provided by the embodiment of the present application.

FIG. 5 is a simulated color gamut diagram of the device provided by the embodiment of the present application.

FIG. 6 is an electrochemical polymerization substrate provided by the embodiment of the present application.

### DETAILED DESCRIPTION OF PREFERRED EMBODIMENTS

Technical solutions in embodiments of the present application will be clearly and completely described below in combination with accompanying drawings in the embodiments of the present application. Obviously, the described embodiments are only part of the embodiments of the present application, not all of them. Based on the embodiments in the present application, all other embodiments obtained by those skilled in the art without making creative work fall within a scope of protection of the present application. In addition, it should be understood that specific embodiments described herein are only for a purpose of explaining and interpreting the present application and are not intended to limit the present application. The terms first, second, third, etc. are only used as signs, without imposing numerical requirements or establishing order. In the present application, in an absence of a contrary explanation, location words used, such as “up” and “down”, usually refer to up and down of a device in its actual use or working state, specifically drawing directions in attached drawings; and words “inside” and “outside” are for an outline of the device.

The inventor found that there are some problems in existing electrochromic display devices, most of the devices can only realize black-and-white display; some colored display devices are composed of three RGB sub-pixels arranged in parallel; when the colored display devices are used as reflective display devices, this design will significantly reduce reflectivity and color gamut of the devices. Moreover, there are difficulties in a pixelation process of materials of existing color electrochromic display devices.

Embodiments of the present application provides an electrochromic display device and a manufacturing method thereof. Following is a detailed description. It should be noted that an order of description of the following embodiments is not a limitation of a preferred order of the embodiments.

An embodiment of the present application provides the electrochromic display device, which includes a first transparent substrate and electrochromic pixel arrays, the electrochromic pixel arrays are disposed on the first transparent substrate. Further, the electrochromic pixel arrays include a plurality of structural units superimposed longitudinally on the first transparent substrate, and a second transparent substrate disposed on each of the structural units.

The electrochromic pixel arrays of the present application include a cyan structural unit (C), a magenta structural unit (M), and a yellow structural unit (Y). It is conceivable that a whole device of the present application consists of superimposed electrochromic devices with three colors including cyan, magenta, and yellow (CMY), so that the device of the present application can display by using transmission and reflection of ambient light, and without using backlight, thereby achieving full-color display in a wide color gamut.

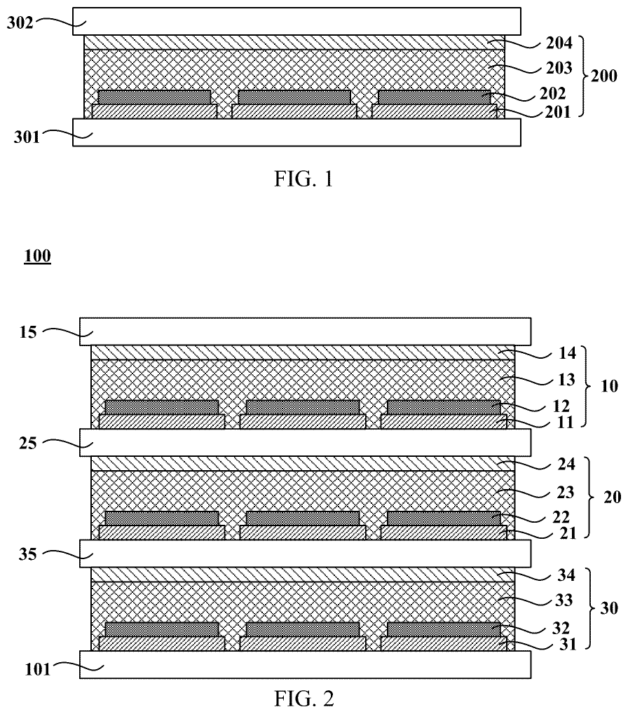

In the embodiment of the present application, it is known that the electrochromic pixel arrays include the plurality of structural units, wherein each of the structural units includes a common electrode, an electrochromic layer, an electrolyte, and a pixel electrode. Further, the electrochromic layer is disposed between the common electrode and the pixel electrode, and is disposed on a surface of the pixel electrode. Further, by filling or pouring the electrolyte into the structural units, and at this time, the electrochromic layer is equivalent to being disposed in the electrolyte. For example, in the embodiment of the present application, a structure of any one of the structural units can be referred to FIG. 1, a structural unit 200 includes: the pixel electrode 201, the electrochromic layer 202, the electrolyte 203, and the common electrode 204. An upper side and a lower side of the structural unit 200 are transparent substrates 301/302. Further, a material of the electrochromic layer selected is an organic polymer material, which can realize pixelation of the material through an electrochemical polymerization method.

Further, each of the structural units is independently selected from one of the cyan structural unit, the magenta structural unit, and the yellow structural unit.

In some embodiments, the common electrode and the pixel electrode are transparent electrodes. The pixel electrode is connected to a thin film transistor (TFT).

In some embodiments, the electrolyte of the embodiment of the present application can be an electrolyte solution including lithium ions (Li⁺). For example, the electrolyte can be formed by dissolving various lithium salts in solvents.

In some embodiments, the electrolyte of the embodiment of the present application can also be ionic liquids. Further, the ionic liquids are liquids that are molten salts at room temperature, and consist of dissociated ions, and does not contain solvents. For example, the ionic liquids are selected from one or more of trifluoromethane sulfonimide ([Tf₂N]), 1-butyl-3-methylimidazolium tetrafluoroborate ([Bmim][BF₄]), 1-butyl-3-methylimidazolium hexafluorophosphate ([Bmim][PF₆]).

In the embodiment of the present application, a function of the electrolyte solution and the electrolyte are mainly to provide ions for an electrochromic reaction. A color-changing mechanism of a polymer electrochromic material is as follows: ions of the electrolyte are doped into a polymer under an action of an external electric field, which changes a light absorption performance of the material to generate color changes; and positive and negative electrodes are isolated, so that only ionic conductivity occurs in the device, and electronic conductivity will not occur. Since the electrochromic polymer itself is a conductive polymer, electrons can transfer on conjugated π-bonds of the electrochromic polymer; and if an upper electrode and a lower electrode directly contact the polymer, electronic conductivity will occur, and the electrochromic reaction will not occur.

The electrochromic layer is located in the electrolyte, and a surface of the electrochromic layer is in contact with the electrolyte. At this time, the electrochromic layer located in the electrolyte will be in a transparent state or a colored state based on an applied voltage. Further, the electrochromic layer is in the transparent state (a fading state) when a positive voltage is applied; and the electrochromic layer is in the colored state when a negative voltage is applied. If colored voltages of the electrochromic layer are different, degree of the colored state are also different.

In some embodiments, for the polymer electrochromic material: a complete colored voltage V_{cm} ranges from −2 V to 0 V; a completely faded voltage V_{bm} ranges from 0 V to +2 V. For example, a positive voltage of the colored state can be −1.9 V, −1.8 V, −1.7 V, −1.5 V, −1.4 V, −1.2 V, −1.0 V, −0.8 V, −0.6 V, −0.5 V, −0.4 V, −0.3 V, −0.2 V, −0.1 V, or −0.05 V. For example, a positive voltage of the transparent state can be +0.05 V, +0.1 V, +0.2 V, +0.3 V, +0.4 V, +0.5 V, +0.6 V, +0.8 V, +1.0 V, +1.2 V, +1.5 V, +1.6 V, +1.8 V, or +1.9 V It is understood that coloring or fading of the electrochromic layer can be controlled based on the above voltages.

For example, the cyan structural unit is in the transparent state when the positive voltage is applied and is present as cyan when the negative voltage is applied. Moreover, with different voltages, degree of cyan will be different.

For example, the magenta structural unit is in the transparent state when the positive voltage is applied and is present as magenta when the negative voltage is applied. Moreover, with different voltages, degree of magenta will be different.

For example, the yellow structural unit is in the transparent state when the positive voltage is applied and is present as yellow when the negative voltage is applied. Moreover, with different voltages, degree of yellow will be different.

In the embodiment of the present application, voltages applied to electrochromic layers of each of the structural units can be same or different.

Further, the electrochromic layer of the cyan structural unit includes a cyan polymer electrochromic material, and an absorption peak of a colored state of the cyan polymer electrochromic material is in a red-light wave band (600 nm-800 nm), in which the electrochromic layer of the cyan structural unit displays cyan.

Further, the electrochromic layer of the magenta structural unit includes a magenta polymer electrochromic material, and an absorption peak of a colored state of the magenta polymer electrochromic material is in a green-light wave band (500 nm-600 nm), in which the electrochromic layer of the magenta structural unit displays magenta.

Further, the electrochromic layer of the yellow structural unit includes a yellow polymer electrochromic material, and an absorption peak of a colored state of the yellow polymer electrochromic material is in a blue-light wave band (400 nm-500 nm), in which the electrochromic layer of the yellow structural unit displays yellow.

In the embodiment of the present application, the electrochromic pixel arrays can include the yellow structural unit, the magenta structural unit, and the cyan structural unit disposed on the first transparent substrate in sequence, as shown in FIG. 2. In addition, the electrochromic pixel arrays can also be other arrangements and combinations of the three structural units. For example, the electrochromic pixel arrays can include the magenta structural unit, the yellow structural unit, and the cyan structural unit disposed on the first transparent substrate in sequence.

Referring to FIG. 2, the electrochromic display device 100 of the embodiment of the present application includes the first transparent substrate 101 and the electrochromic pixel arrays disposed on the first transparent substrate 101; the electrochromic pixel arrays includes the yellow structural unit 30, a second transparent substrate 35 disposed on the yellow structural unit 30, the magenta structural unit 20, a third transparent substrate 25 disposed on the magenta structural unit 20, the cyan structural unit 10, and a fourth transparent substrate 15 disposed on the cyan structural unit 10, which are disposed in sequence on the first transparent substrate 101. It can be understood that first, second, third, and fourth here are only used as indications, the third transparent substrate and the fourth transparent substrate are located above a corresponding structural unit, which are similar to the second transparent substrate.

Further, please continue to refer to FIG. 2, the yellow structural unit 30 includes a third common electrode 34, a third electrolyte 33, a yellow electrochromic layer 32, and a third pixel electrode 31 disposed in sequence. Specifically, the third pixel electrode 31 is disposed on the first transparent substrate 101, the yellow electrochromic layer 32 is disposed on a surface of the third pixel electrode 31, and the third electrolyte 33 is located between the first transparent substrate 101 and the third common electrode 34. Meanwhile, the yellow electrochromic layer 32 is located in the third electrolyte 33 and is in the transparent state or the colored state based on an applied voltage. Further, the electrochromic layer of the yellow structural unit includes the yellow polymer electrochromic material.

Further, please continue to refer to FIG. 2, the magenta structural unit 20 includes a second common electrode 24, a second electrolyte 23, a magenta electrochromic layer 22, and a second pixel electrode 21 disposed in sequence. Specifically, the second pixel electrode 21 is disposed on the second transparent substrate 35, the magenta electrochromic layer 22 is disposed on a surface of the second pixel electrode 21, and the second electrolyte 23 is located between the second transparent substrate 35 and the second common electrode 24. At a same time, the magenta electrochromic layer 22 is located in the second electrolyte 23 and is in the transparent state or the colored state based on an applied voltage. Further, the electrochromic layer of the magenta structural unit includes the magenta polymer electrochromic material.

Further, please continue to refer to FIG. 2, the cyan structural unit 10 includes a first common electrode 14, a first electrolyte 13, a cyan electrochromic layer 12, and a first pixel electrode 11 disposed in sequence. Specifically, the first pixel electrode 11 is disposed on the third transparent substrate 25, the cyan electrochromic layer 12 is disposed on the first pixel electrode 11, and the first electrolyte 13 is located between the third transparent substrate 25 and the first common electrode 14. At a same time, the cyan electrochromic layer 12 is in the first electrolyte 13 and is in the transparent state or the colored state based on an applied voltage. Further, the electrochromic layer of the cyan structural unit includes the cyan polymer electrochromic material.

It is conceivable that in the embodiment of the present application, the electrolyte in the structural unit is disposed between the common electrode of the structural unit and the transparent substrate located below the structural unit.

In some embodiments, materials of the electrochromic layer include organic polymer electrochromic materials. The organic polymer electrochromic materials include at least one of polypyrrole, polythiophene, and polyaniline.

In the embodiment of the present application, materials of the organic polymer electrochromic materials that can undergo an electrochemical polymerization reaction are mainly polythiophene, polypyrrole, and polyaniline monomers. Moreover, the organic polymer electrochromic materials have following characteristics: the fading state is transparent, and coloring states are cyan, magenta, and yellow, respectively; and the electrochemical polymerization reaction can occur, which is convenient for the pixelation of the materials. In addition, colors of color-changing materials can be adjusted by changing functional groups.

Further, the organic polymer electrochromic materials of the embodiment of the present application can be a polythiophene polymer, and three materials are specifically listed below.

For example, a structural formula of the cyan polymer electrochromic material can be:

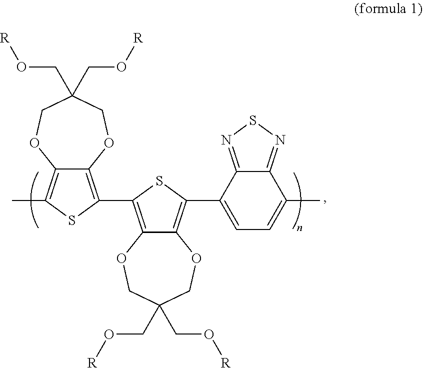

wherein R is 2-ethylhexyl.

For example, a structural formula of the magenta polymer electrochromic material can be:

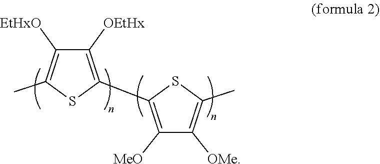

For example, a structural formula of the yellow polymer electrochromic material can be:

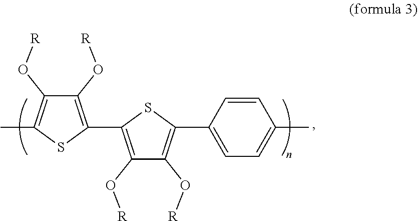

wherein R is 2-ethylhexyl.

Degrees of polymerization n of the above organic polymer electrochromic materials are not particularly limited. The degrees of polymerization n of electrochromic polymers are generally not considered when researching their electrochromic performance, the embodiment of the present application may only consider transmittance change values corresponding to a film thickness of the electrochromic layer.

In the embodiment of the present application, in order to ensure best optical performance of the device, it is necessary to maximize a change of transmittance between the colored state and the faded state of the electrochromic layer. At this time, a thickness of a polymer film generally ranges from 100 nm to 5 μm, that is, a thickness of the electrochromic layer ranges from 100 nm to 5 μm. For example, the thickness of the electrochromic layer can be 100 nm, 200 nm, 300 nm, 400 nm, 500 nm, 600 nm, 700 nm, 800 nm, 900 nm, 1 μm, 2 μm, 3 μm, 4 μm, or 5 μm.

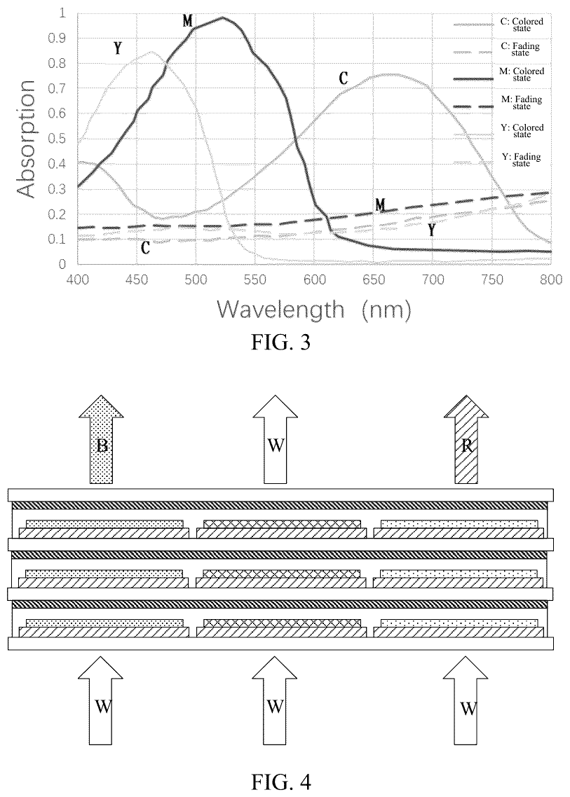

Absorption spectrums of the polymer electrochromic materials (polythiophene derivatives) of the formula 1, the formula 2, and the formula 3 in the embodiment of the present application is shown in FIG. 3.

According to FIG. 3, absorption peaks of the absorption spectrums of the cyan polymer electrochromic material (C), the magenta polymer electrochromic material (M), and the yellow polymer electrochromic material (Y) in the colored state are in the red-light wave band (600 nm-800 nm), the green-light wave band (500 nm-600 nm), and the blue-light wave band (400 nm-500 nm), respectively, and after passing through polymer films in the colored state, white light displays cyan, magenta, and yellow, respectively. Moreover, the absorption peaks of the polymer electrochromic materials can change continuously with changes of voltages, so that each pixel can achieve gray-scale regulation from the transparent state to the colored state.

Specifically, please refer to FIG. 4. FIG. 4 a schematic diagram of a color-changing display of the electrochromic display device, in which the device has three structural units, the three structural units are the cyan structural unit (C), the magenta structural unit (M), and the yellow structural unit (Y) from top to bottom. Taking the device shown in FIG. 4 as an example, a display control method of a single pixel will be described. In FIG. 4, for the single pixel composed of three sub-pixels in a column on a left, if the single pixel is required to display blue, an upper cyan electrochromic layer (a C layer) needs to be colored to absorb red light in the red-light wave band of ambient white light, then a middle magenta electrochromic layer (an M layer) needs to be colored to absorb green light in the green-light wave band of the ambient white light, a lower yellow electrochromic layer (a Y layer) fades to be in the transparent state and does not absorb light, and finally, in the ambient white light passing through the three sub-pixels, only blue light in a blue-light wave band reserve, and the single pixel displays blue (B). Similarly, if a rightmost row of pixels in FIG. 4 is required to display red, the M layer and the Y layer need to be colored, and the C layer needs to be faded, at this time, green light and blue light of the ambient white light transmitted through are absorbed, and the pixel displays red (R). If three sub-pixels in a middle column of FIG. 4 are in a faded transparent state, the single pixel will transmit the ambient white light (W) to display transparent.

If controlling the single sub-pixel to be colored is required, the negative voltage can be applied to a pixel electrode side, and the positive voltage can be applied to a common electrode side. If controlling the single sub-pixel to be faded is required, the positive voltage can be applied to the pixel electrode side, and the negative voltage can be applied to the common electrode side. If pulling up a voltage to V_{cm} (the negative voltage), the single sub-pixel can completely be colored to reach highest gray-scale, and if pulling up a voltage to V_{bm} (the positive voltage), the single sub-pixel will be completely faded to be in the transparent state. Since intensity of the absorption peaks of the electrochromic layers can continuously change with applied voltages, we can equally divide 0V−V_{cm} into several negative voltages in gray-scale colored state, and by giving corresponding gray-scale voltages, the sub-pixel can achieve a specified gray-scale display effect.

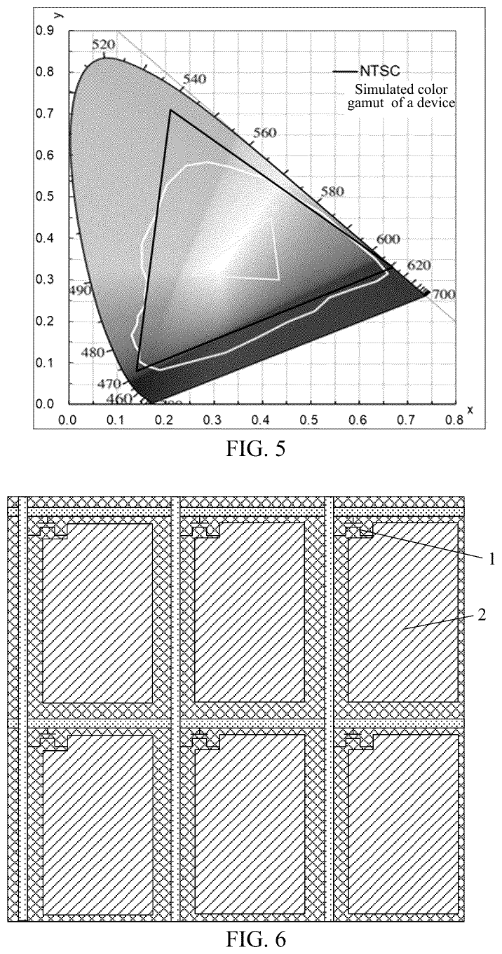

Further, please refer to a simulated color gamut diagram of the device in FIG. 5. In the electrochromic display device, the three CMY sub-pixels (the structural units) are superimposed, and a voltage applied to the single sub-pixel is controlled by the TFT to control gray-scale of the single sub-pixel, so as to control absorption degrees of three film layers to red light, green light, and blue light, respectively. Transmitted and reflected ambient white light will pass through the three sub-pixels of different gray-scales at a same time, which finally mixes to form light of other colors. Through gray-scale regulation of each of the sub-pixels, a full-color display with wide color gamut can be realized. This device can display by using transmission and reflection of the ambient light, without using backlight. The simulated color gamut of the device based on three preferred materials is shown in FIG. 5, wherein the color gamut can reach 8.5% NTSC. When the three sub-pixels are in the transparent state, the whole pixel is transparent, and a transparent display effect can be achieved.

The electrochromic display device of the present application can be a full-color electrochromic display device with a transparent reflection-mode.

An embodiment of the present application provides a manufacturing method of the electrochromic display device, including following steps:
providing a first transparent substrate; and
forming a plurality of structural units superimposed longitudinally, and a second transparent substrate on the first transparent substrate, that is, forming an electrochromic pixel arrays on the first transparent substrate; the electrochromic pixel arrays including a cyan structural unit, a magenta structural unit, and a yellow structural unit;
wherein a manufacturing method of each of the structural units includes: forming a pixel electrode, an electrochromic layer, and a common electrode in sequence, the electrochromic layer is formed on a surface of the pixel electrode; and filling an electrolyte, so as to obtain the each of the structural units; the structural units are independently selected from one of the cyan structural unit, the magenta structural unit, and the yellow structural unit.

In some embodiments of the present application, the electrochromic layer is prepared by an electrochemical polymerization process, which includes a following step:
immersing the pixel electrode in the electrolyte including at least one electrochromic polymer monomer, and forming a film by polymerizing the electrochromic polymer monomer on a surface of the pixel electrode under an action of an external voltage, thereby obtaining the electrochromic layer.

Materials of the electrochromic layer in the present application are selected from polypyrrole, polythiophene, and polyaniline, which have following characteristics: monomers can undergo an electrochemical polymerization reaction to generate polymer electrochromic materials; and in the electrolyte, polymer films become a faded transparent state when a positive voltage is applied, and becomes CMY colored states when a negative voltage is applied.

Specifically, please refer to FIG. 6, the pixelation of the polymer electrochromic materials uses the electrochemical polymerization process. A TFT substrate is used as an electrochemical polymerization substrate, which has a same structure with the TFT substrate used in common liquid crystal display (LCD) panels, and a basic structure of the electrochemical polymerization substrate is shown in FIG. 6. In FIG. 6, 1 is a TFT switch and 2 is a transparent pixel electrode. In the process of electrochemical polymerization, all TFTs are turned on, all transparent pixel electrodes are connected as working electrodes, and platinum sheets or platinum wires are used as counter electrodes. By putting the working electrodes, the counter electrodes, and reference electrodes into the electrolyte including electrochromic polymer monomers, the film will be formed by polymerizing the monomer on the surface of the transparent pixel electrodes under the action of the external voltage, while monomers in an area without the pixel electrodes will not polymerize, so as to realize the pixelation of the polymer electrochromic materials, thereby forming the electrochromic layer on the transparent pixel electrode.

Further, after the pixelation of the electrochemical polymer materials, the TFT substrate and an opposite common electrode substrate are formed into a box, and the electrolyte is filled into the box to complete a manufacturing of an electrochromic device with a CMY single-layer sub-pixel. By aligning and attaching three CMY structural units, the manufacturing of a whole display device can be completed.

To sum up, compared with a design in which RGB sub-pixels are arranged side-by-side, the electrochromic display device of the present application adopts a laminated design of CMY pixel units to provide a non-active light-emitting display device, which greatly improves color gamut, reflectivity, and resolution. CMY electrochromic materials selected are organic polymer materials, which can realize the pixelation of the materials by the electrochemical polymerization method. The electrochromic display device of the present application can be a full-color reflective display device including electrochromic polymers, which depends on ambient light to display, and can be used in an outdoor display field such as an outdoor billboard, a shop window, a vehicle glass, a building curtain wall, etc.

The above describes in detail the electrochromic display device and the manufacturing method thereof provided by the embodiments of the present application. In this paper, specific examples are applied to explain a principle and an implementation mode of the present application. The description of the above embodiment is only used to help understand the method and a core idea of the present application; at the same time, for those skilled in the art, there will be changes in a specific implementation mode and an application scope according to the idea of the present application. To sum up, content of the specification should not be understood as a limitation of the present application.

What is claimed is:

1. An electrochromic display device, comprising a first transparent substrate and electrochromic pixel arrays disposed on the first transparent substrate, wherein the electrochromic pixel arrays comprise a yellow structural unit, a second transparent substrate, a magenta structural unit, a third transparent substrate, a cyan structural unit, and a fourth transparent substrate disposed on the first transparent substrate in sequence;
the cyan structural unit comprises a first common electrode, a first electrolyte, a cyan electrochromic layer, and a first pixel electrode disposed in sequence; the first pixel electrode is disposed on the third transparent substrate, the cyan electrochromic layer is disposed on the first pixel electrode, and the first electrolyte is located between the third transparent substrate and the first common electrode; the cyan electrochromic layer is in the first electrolyte and is in a transparent state or a colored state based on an applied voltage;
the magenta structural unit comprises a second common electrode, a second electrolyte, a magenta electrochromic layer, and a second pixel electrode disposed in sequence; the second pixel electrode is disposed on the second transparent substrate, the magenta electrochromic layer is disposed on a surface of the second pixel electrode, and the second electrolyte is located between the second transparent substrate and the second common electrode; the magenta electrochromic layer is located in the second electrolyte and is in the transparent state or the colored state based on an applied voltage; and
the yellow structural unit comprises a third common electrode, a third electrolyte, a yellow electrochromic layer, and a third pixel electrode disposed in sequence; the third pixel electrode is disposed on the first transparent substrate, the yellow electrochromic layer is disposed on a surface of the third pixel electrode, and the third electrolyte is located between the first transparent substrate and the third common electrode; the yellow electrochromic layer is located in the third electrolyte and is in the transparent state or the colored state based on an applied voltage.

2. The electrochromic display device according to claim 1, wherein the cyan structural unit is in the transparent state when a positive voltage is applied and is cyan when a negative voltage is applied;
the magenta structural unit is in the transparent state when a positive voltage is applied and is magenta when a negative voltage is applied; and
the yellow structural unit is in the transparent state when a positive voltage is applied and is yellow when a negative voltage is applied.

3. An electrochromic display device, comprising a first transparent substrate and an electrochromic pixel arrays disposed on the first transparent substrate, wherein the electrochromic pixel arrays comprises a plurality of structural units superimposed longitudinally, and a second transparent substrate disposed on each of the structural units;
the structural units comprise common electrodes, pixel electrodes, and electrochromic layers disposed between the common electrodes and the pixel electrodes, and the electrochromic layers are disposed on surfaces of the pixel electrodes; the structural units further comprise electrolytes, the electrolytes are in contact with the electrochromic layers; the electrochromic layers are in a transparent state or a colored state based on an applied voltage;
the structural units are independently selected from one of a cyan structural unit, a magenta structural unit, and a yellow structural unit; and the electrochromic pixel arrays comprises the cyan structural unit, the magenta structural unit, and the yellow structural unit.

4. The electrochromic display device according to claim 3, wherein a material of the electrochromic layer comprises an organic polymer electrochromic material; the organic polymer electrochromic material comprises at least one of polypyrrole, polythiophene, and polyaniline; and
a thickness of the electrochromic layer ranges from 100 nm to 5 μm.

5. The electrochromic display device according to claim 3, wherein the electrochromic layer of the cyan structural unit comprises a cyan polymer electrochromic material, and an absorption peak of a colored state of the cyan polymer electrochromic material is in a red-light wave band, and the electrochromic layer of the cyan structural unit displays cyan;
the electrochromic layer of the magenta structural unit comprises a magenta polymer electrochromic material, and an absorption peak of a colored state of the magenta polymer electrochromic material is in a green-light wave band, and the electrochromic layer of the magenta structural unit displays magenta; and
the electrochromic layer of the yellow structural unit comprises a yellow polymer electrochromic material, and an absorption peak of a colored state of the yellow polymer electrochromic material is in a blue-light wave band, and the electrochromic layer of the yellow structural unit displays yellow.

6. The electrochromic display device according to claim 3, wherein the electrochromic layer of the cyan structural unit comprises a cyan polymer electrochromic material, and an absorption peak of a colored state of the cyan polymer electrochromic material is in a red-light wave band, and the electrochromic layer of the cyan structural unit displays cyan.

7. The electrochromic display device according to claim 3, wherein the electrochromic layer of the magenta structural unit comprises a magenta polymer electrochromic material, and an absorption peak of a colored state of the magenta polymer electrochromic material is in a green-light wave band, and the electrochromic layer of the magenta structural unit displays magenta.

8. The electrochromic display device according to claim 3, wherein the electrochromic layer of the yellow structural unit comprises a yellow polymer electrochromic material, and an absorption peak of a colored state of the yellow polymer electrochromic material is in a blue-light wave band, in which the electrochromic layer of the yellow structural unit displays yellow.

9. The electrochromic display device according to claim 3, wherein the electrochromic layer is disposed in the electrolyte; the electrolyte comprises lithium ions and/or ionic liquids;
the ionic liquids are selected from one or more of trifluoromethane sulfonimide, 1-butyl-3-methylimidazolium tetrafluoroborate, and 1-butyl-3-methylimidazolium hexafluorophosphate.

10. The electrochromic display device according to claim 3, wherein the electrochromic layer is in the transparent state when a positive voltage is applied; and the electrochromic layer is in the colored state when a negative voltage is applied.

11. The electrochromic display device according to claim 3, wherein voltages of the electrochromic layers of each of the structural units are same.

12. The electrochromic display device according to claim 3, wherein voltages of the electrochromic layers of each of the structural units are different.

13. The electrochromic display device according to claim 3, wherein the common electrodes and the pixel electrodes are transparent electrodes; and
the pixel electrodes are connected to a thin film transistor.

14. The electrochromic display device according to claim 3, wherein the cyan structural unit comprises a first common electrode, a first electrolyte, a cyan electrochromic layer, and a first pixel electrode;
the magenta structural unit comprises a second common electrode, a second electrolyte, a magenta electrochromic layer, and a second pixel electrode; and
the yellow structural unit comprises a third common electrode, a third electrolyte, a yellow electrochromic layer, and a third pixel electrode.

15. The electrochromic display device according to claim 14, wherein the third pixel electrode is disposed on the first transparent substrate, the yellow electrochromic layer is disposed on a surface of the third pixel electrode, and the third electrolyte is located between the first transparent substrate and the third common electrode; the yellow electrochromic layer is located in the third electrolyte and is in the transparent state or the colored state based on the applied voltage.

16. The electrochromic display device according to claim 14, wherein the second pixel electrode is disposed on the second transparent substrate, the magenta electrochromic layer is disposed on a surface of the second pixel electrode, and the second electrolyte is located between the second transparent substrate and the second common electrode; the magenta electrochromic layer is located in the second electrolyte and is in the transparent state or the colored state based on the applied voltage.

17. The electrochromic display device according to claim 14, wherein the first pixel electrode is disposed on a third transparent substrate, the cyan electrochromic layer is disposed on the first pixel electrode, and the first electrolyte is located between the third transparent substrate and the first common electrode; the cyan electrochromic layer is in the first electrolyte and is in the transparent state or the colored state based on the applied voltage.

18. The electrochromic display device according to claim 5, wherein a structural formula of the cyan polymer electrochromic material is as follows: 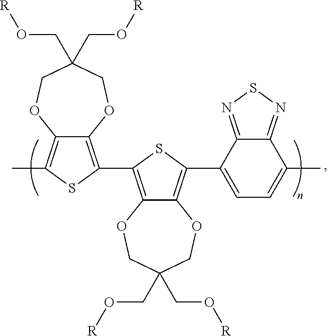
wherein R is 2-ethylhexyl;
a structural formula of the magenta polymer electrochromic material is as follows: 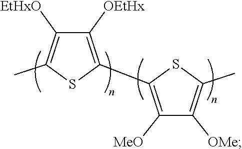
and
a structural formula of the yellow polymer electrochromic material is as follows: 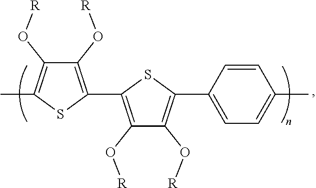
wherein R is 2-ethylhexyl.

19. A manufacturing method of an electrochromic display device, comprising following steps:
providing a first transparent substrate; and
forming a plurality of structural units superimposed longitudinally, and a second transparent substrate on the first transparent substrate, that is, forming electrochromic pixel arrays on the first transparent substrate; the electrochromic pixel arrays comprising a cyan structural unit, a magenta structural unit, and a yellow structural unit;
wherein a manufacturing method of each of the structural units comprises: forming a pixel electrode, an electrochromic layer, and a common electrode in sequence, the electrochromic layer is formed on a surface of the pixel electrode; and filling an electrolyte, so as to obtain the structural units; the structural units are independently selected from one of the cyan structural unit, the magenta structural unit, and the yellow structural unit.

20. The manufacturing method of the electrochromic display device according to claim 19, wherein the electrochromic layer is prepared by an electrochemical polymerization process, and comprises a following step:
immersing the pixel electrode in the electrolyte comprising at least one electrochromic polymer monomer and forming a film by polymerizing the electrochromic polymer monomer on a surface of the pixel electrode under an action of an external voltage, thereby obtaining the electrochromic layer.
